(19) United States
(12) Patent Application Publication
(10) Pub. No.: US 2009/0049990 A1
(43) Pub. Date: Feb. 26, 2009

(54) STEAMER INSERT APPARATUS

(76) Inventor: William Christopher Schutte, Suwanee, GA (US)

Correspondence Address: GEORGE R. REARDON, 3356 STATION COURT, LAWRENCVILLE, GA, 30044, US

(21) Appl. No.: 11/923,465

(22) Filed: Oct. 24, 2007

Related U.S. Application Data
(60) Provisional application No. 60/957,624, filed on Aug. 23, 2007.

(51) Int. Cl. A47J 44/00

(52) U.S. Cl. 99/339; 426/474; 99/413

(57) ABSTRACT

An insert for a kitchen pot that facilitates the steaming of hot dog buns while providing access for inserting and retrieving hot dogs into boiling water in the pot is disclosed. The steamer insert releasably attaches to a kitchen pot and has an opening that is dimensioned for insertion and retrieval of at least one hot dog through the insert into boiling water in the cooking container, where the top of the boiling water is positioned below the bottom of the insert. The steamer insert has pivoting handles that: fold for compact storage of the insert; adapt to different diameter pots, accommodate the placement of the pot lid on the handles.

This application claims the benefit of the filing date of U.S. Provisional Patent Application 60/957,624 filed on Aug. 23, 2007, which is incorporated herein in its entirety.

### FIELD OF THE INVENTION

The technology disclosed herein relates generally to inserts for kitchen pots. More particularly, the technology disclosed herein relates to an insert for a kitchen pot that facilitates the steaming of hot dog buns while providing access for inserting and retrieving hot dogs into boiling water in the pot.

### BACKGROUND OF THE INVENTION

A hot dog is a type of fully-cooked, cured and/or smoked moist sausage of soft, even texture and flavor. It is usually placed hot in a soft, sliced bun of approximately the same length as the sausage, and optionally garnished with condiments and toppings.

During home preparation hot dogs are traditionally boiled in a pot of boiling water until the hot dogs become plump. A long standing problem has been how to warm up the hot dog buns so that the boiled hot dog is not placed into a cold bun.

One solution offered commercially is an electrical device having a hot dog recess and a hot dog bun recess. The user inserts the hot dog into the hot dog recess and the hot dog bun into the hot dog bun recess; plugs in the device to an electrical receptacle and activates the device. One brand allows the grilling of up to five hot dogs and the warming of two buns simultaneously. Problems associated with this solution include: its price (suggested retail of $49.95; some users do not want their hot dogs grilled; some users prefer their buns soft, not toasted and crunchy. What is needed is a device that is more economically priced and produces hot dogs that are not grilled and buns that are not toasted and crunchy.

Related art that addresses these and other problems includes the following patents.

U.S. Pat. No. 3,782,664, issued to Bennett on Aug. 8, 1972, discloses a bun warmer and steamer and hotdog cooker.

U.S. Pat. No. 4,052,934, issued to Shinman on Oct. 11, 1977, discloses a device for attachment to a frying pan, cooking pot or like cooking utensil. The device comprises an openwork substantially flat metal base of circular segment shape, a flange upstanding from the circumference of the base and support means located at or near the circumference of the base for supporting the device on the rim of the cooking utensil in an easily attachable and detachable manner.

U.S. Pat. No. 4,332,189, issued to Stuck on Jun. 1, 1982, discloses an apparatus and method for preparing foodstuffs, and particularly sausages and buns such as hot dogs. A reservoir containing heated water is provided and sausages are immersed in and moved through the heated water by a conveyor while buns are moved through heated vapor from the heated water to heat the sausages and buns to a desired serving temperature.

U.S. Pat. No. 4,677,905, issued to Johnson on Jul. 7, 1987, discloses a food heating apparatus placeable over boiling water, the apparatus comprising a plate including a generally planar upper surface and a lower surface generally parallel to the upper surface, the plate having therethrough a plurality of steam passages extending between the lower surface and the upper surface, each of the steam passages communicating with the upper surface through a first opening having a first area and communicating with the lower surface through a second opening having a second area substantially greater than the first area.

U.S. Pat. No. 5,195,424, issued to Guajaca on Mar. 23, 1993, discloses a steamer for tamales and other comestibles having a rack capable of supporting foods being cooked therein at an inclined orientation. The rack is provided with a number of horizontal tiers or assemblies each constructed of rings joined by radially positioned spokes. Corresponding rings within each of the rack's assemblies increase in size from the top to the bottom of the rack establishing conically shaped surfaces upon which comestibles may be positively supported at an incline. The spokes connecting the rings of each of the assemblies are vertically oriented one above the other and divide the rack into separate receptacles for segregating foods during cooking. Two or more racks may be stacked within the steamer's open-topped vessel thereby increasing its cooking capacity.

U.S. Pat. No. D341,990, issued to Yim on Dec. 7, 1993, illustrates a steamer basket for a food steamer.

U.S. Pat. No. 5,913,966, issued to Armone et al. on Jun. 22, 1999, discloses an improved pan that can also be used as a steaming utensil on top of an ordinary pot; the pan comprises a receptacle that has a flat bottom and a side wall whose top edge has a chord-truncated circular shape and a flange. The area defined by the chord-truncated circular shape is made as large as desired without voiding access to the pot below and without increasing the predetermined radius of the receptacle. The above preferred embodiment can also have a multiplicity of holes in the bottom. The preferred embodiment is not restricted to an outer pot of given radius; it can be used on top of a variety of pots with radii within a determined range. The combination of the pan and the pot below behaves effectively as a double-compartment vessel. If the lid of the pot below is placed on top of the flange, the steam is substantially diverted toward the receptacle. Thus, the non-perforated preferred embodiment supersedes conventional pans and steamers by giving substantially identical performance thereover while additionally having: (a) a unique, eye-catching design, (b) the functionality of a double-boiler (careful heating of sauces or steaming of vegetables in the receptacle while boiling another substance in the pot below), and (c) an optimal capacity without voiding access to the pot below. In spite of its novel form, all the above multi-functionality is embedded within the familiar shape of a pan. The simple, yet unique, design of the invention, together with its universality of use, has important implications for the marketing of cookware sets whose pan of smallest capacity has been substituted by the pan of the present invention.

U.S. Pat. No. 6,554,053, issued to Rossi on Sep. 3, 2002, discloses a cooking element for a steamer, composed of: a tubular side wall; a removable perforated bottom, the tubular side wall having an interior surface provided with a shoulder on which the perforated bottom rests; a first element carried by the interior surface of the tubular side wall; and a second element carried by, and located beneath, the perforated bottom. The first element is located to block the second element when the perforated bottom rests on the shoulder, one of the elements is a tongue, and the other of the elements is an abutment. A cooking element for a steamer, composed of a tubular side wall, a removable perforated bottom and a removable handle, wherein the perforated bottom has orifices adapted for rapid connection of the removable handle.

U.S. Pat. No. D528,377, issued to Pippel et al., illustrates a cookware steamer grater.

While these patents and other previous methods have attempted to solve the problems that they addressed, none have utilized or disclosed a steamer insert apparatus that facilitates the steaming of hot dog buns during the hot dog boiling process, that is formed for convenient insertion and retrieval of hot dogs through an opening in the insert, that has pivoting handles that position the insert within the kitchen pot while providing for the placement of the pot lid on a corresponding place on the handles, as does embodiments of the technology disclosed herein.

Therefore, a need exists for a steamer insert apparatus with these attributes and functionalities. The steamer insert apparatus according to embodiments of the invention substantially departs from the conventional concepts and designs of the prior art. It can be appreciated that there exists a continuing need for a new and improved steamer insert apparatus which can be used commercially. In this regard, the technology disclosed herein substantially fulfills these objectives.

The foregoing patent and other information reflect the state of the art of which the inventor is aware and are tendered with a view toward discharging the inventor's acknowledged duty of candor in disclosing information that may be pertinent to the patentability of the technology disclosed herein. It is respectfully stipulated, however, that the foregoing patent and other information do not teach or render obvious, singly or when considered in combination, the inventor's claimed invention.

### BRIEF SUMMARY OF THE INVENTION

In general, the technology disclosed herein features a steamer insert that releasably attaches to a cooking container, e.g. a kitchen pot. The steamer insert has an opening that is dimensioned for insertion and retrieval of at least one hot dog through the insert into boiling water in the cooking container, where the top of the boiling water is positioned below the bottom of the insert. The steamer insert has pivoting handles that: fold for compact storage of the insert; adapt to different diameter pots, accommodate the placement of the pot lid on the handles.

In one embodiment this opening has the shape of a cross, where the long portion of the cross-shaped opening is dimensioned to allow the insertion of a hot dog held by a conventional pair of kitchen tongs and the short portion of the cross-shaped opening is dimensioned to allow the kitchen tongs to open and grasp a hot dog in the boiling water within the pot. The steamer insert is also formed to provide a steaming platform for at least one hot dog bun on the top of the insert and above the boiling water. Thus the simultaneous steaming of at least one hot dog bun while at least one hot dog is being boiled can be accomplished.

One advantage of the technology disclosed herein is that it allows the simultaneous boiling of hot dogs and steaming of hot dog buns.

Another advantage of the technology disclosed herein is that it allows easy pot access for the insertion and retrieval of hot dogs.

Another advantage of the technology disclosed herein is that it is efficient to use.

Another advantage of the technology disclosed herein is that it is easy to use.

Another advantage of the technology disclosed herein is that it may be operated with one hand.

Another advantage of the technology disclosed herein is that it may be made from readily available materials.

Another advantage of the technology disclosed herein is that it may be economically produced.

Other objects, advantages and capabilities of the technology disclosed herein are apparent from the following description taken in conjunction with the accompanying drawings showing the preferred embodiment of the invention.

### BRIEF DESCRIPTION OF THE SEVERAL VIEWS OF THE DRAWINGS

The technology disclosed herein, together with further advantages thereof, may best be understood by reference to the following description of the simplest form of the invention, taken in conjunction with the accompanying drawings in which:

FIG. 1 illustrates a perspective view of a steamer insert apparatus, according to an embodiment of the technology disclosed herein.

FIG. 2 illustrates a perspective view of a steamer insert apparatus showing four support legs, according to an embodiment of the technology disclosed herein.

FIG. 3 illustrates a perspective view of a steaming platform, according to an embodiment of the technology disclosed herein.

FIG. 4 illustrates a perspective view of a support leg, according to an embodiment of the technology disclosed herein.

FIG. 5 illustrates a perspective view of a steamer insert apparatus, according to an embodiment of the technology disclosed herein.

FIG. 6 illustrates a perspective view of a steamer insert apparatus showing a pair of tongs inserting a hot dog, according to an embodiment of the technology disclosed herein.

FIG. 7 illustrates a perspective view of a steamer insert apparatus, according to an embodiment of the technology disclosed herein.

FIG. 8 illustrates a perspective view of a steamer insert apparatus, according to an embodiment of the technology disclosed herein.

FIG. 9 illustrates a perspective view of a steamer insert apparatus showing hot dog buns on the steaming platform, according to an embodiment of the technology disclosed herein.

FIG. 10 illustrates a perspective view of a steamer insert apparatus showing two support legs, according to an embodiment of the technology disclosed herein.

FIG. 11 illustrates a perspective view of a support leg, according to an embodiment of the technology disclosed herein.

FIG. 12 illustrates a perspective view of a support leg showing how a pot lid can rest on the lid support section of a support leg, according to an embodiment of the technology disclosed herein.

### DETAILED DESCRIPTION OF THE INVENTION

The technology disclosed herein will now be described in detail with reference to at least one preferred embodiment thereof as illustrated in the accompanying drawings. In the following description, numerous specific details are set forth in order to provide a thorough understanding of the technology disclosed herein. It will be apparent, however, to one skilled in the art, that the technology disclosed herein may be practiced without some or all of these specific details. In other instances, well known operations have not been described in detail so not to unnecessarily obscure the technology disclosed herein.

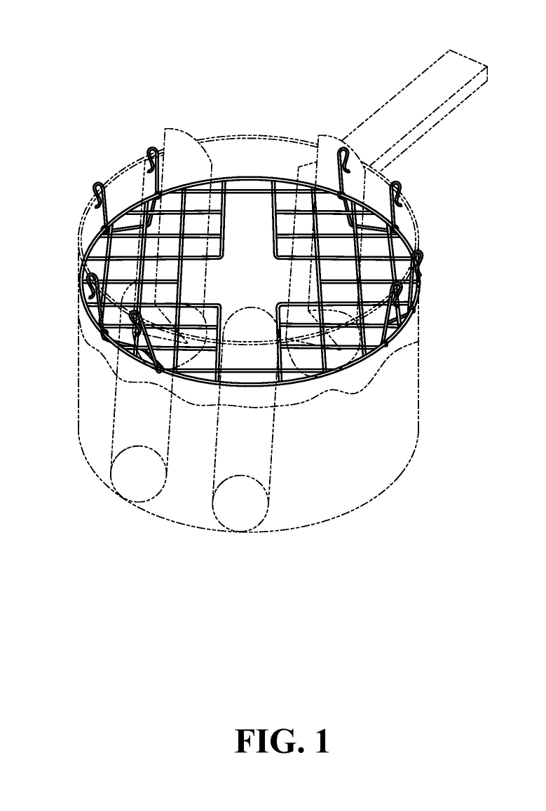

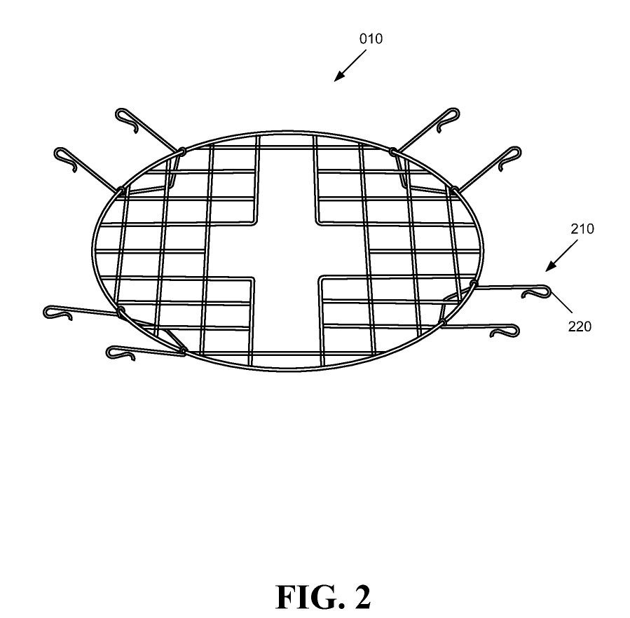

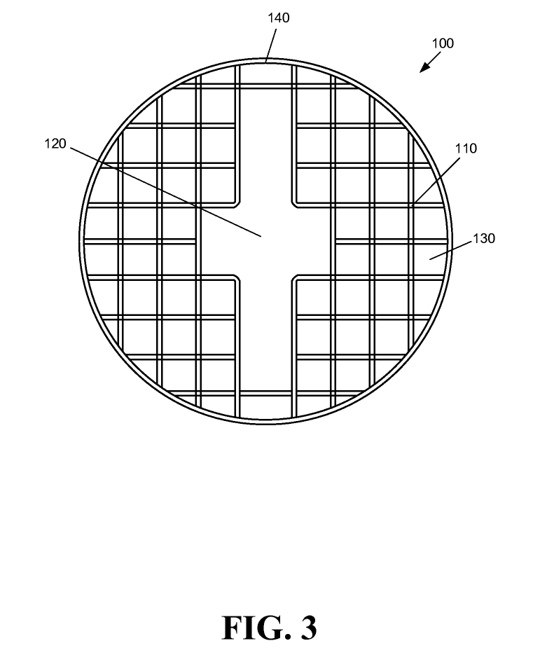

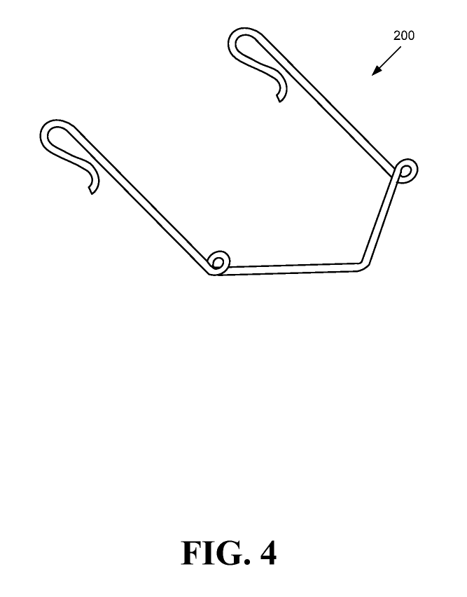

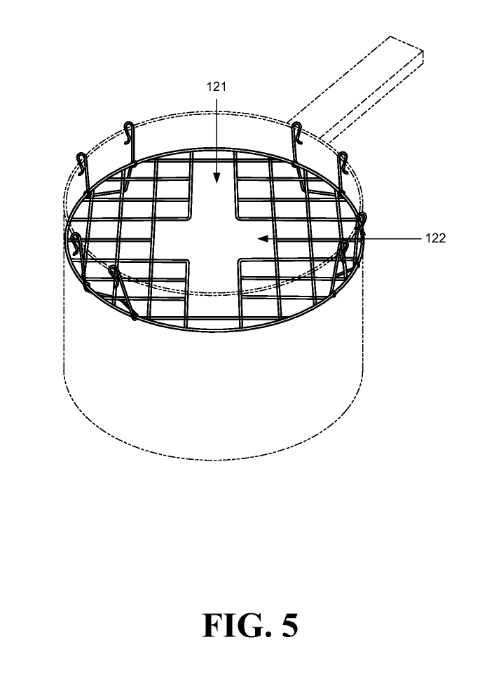

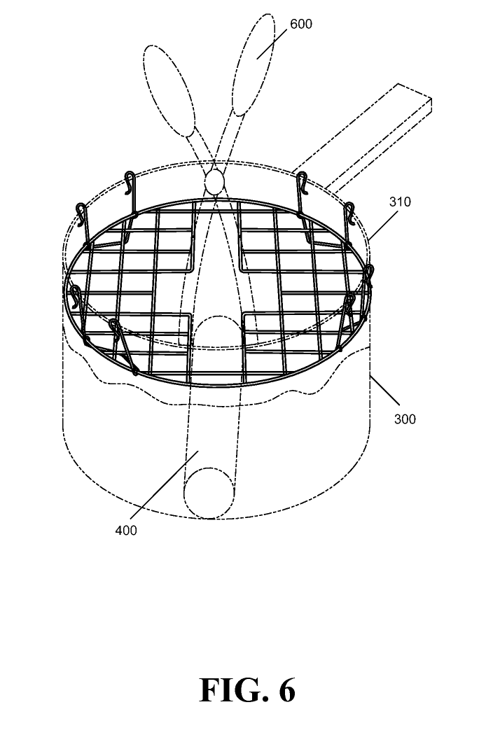

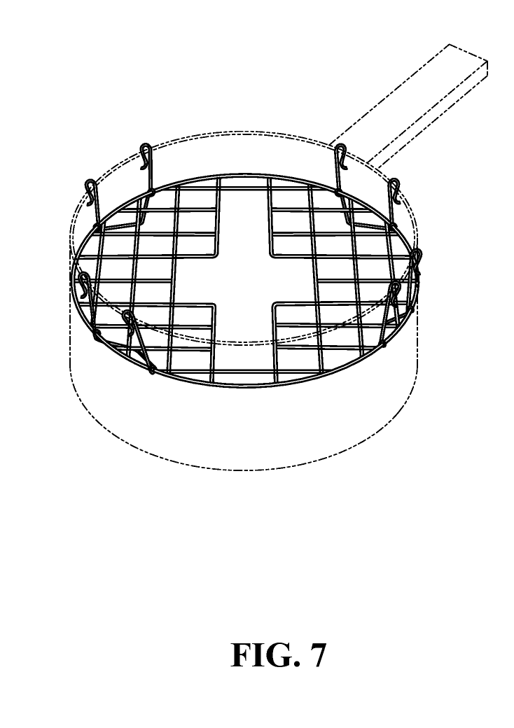

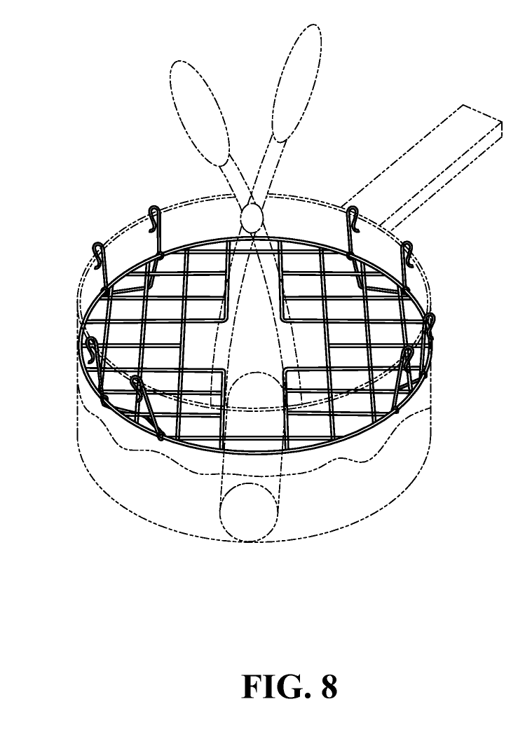

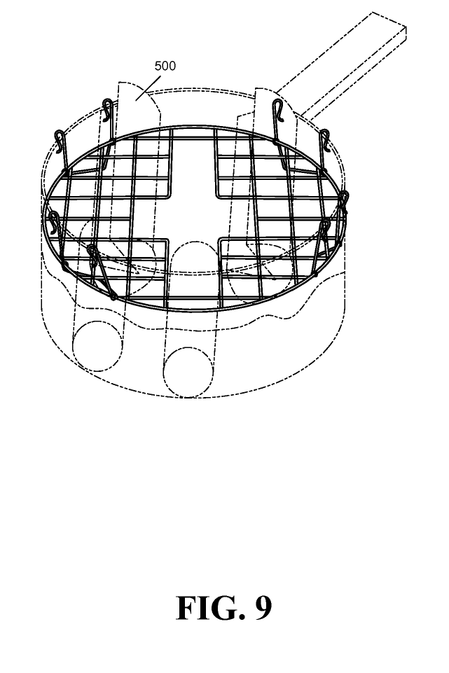

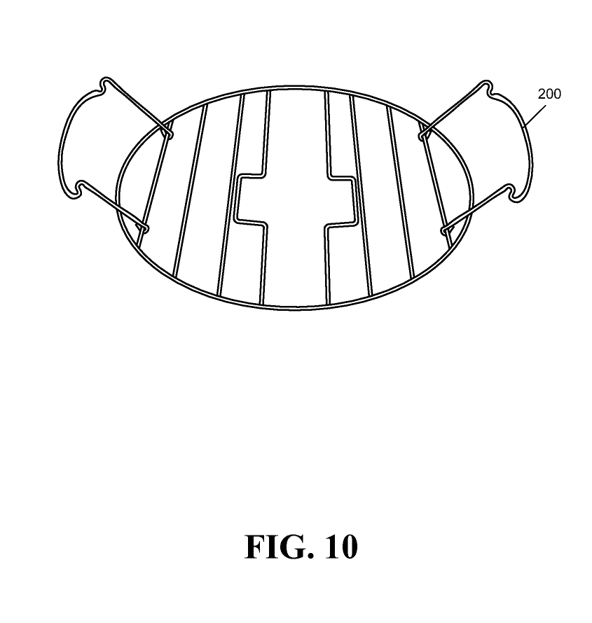

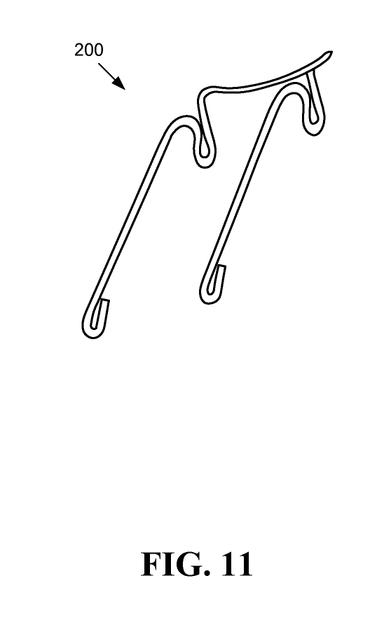

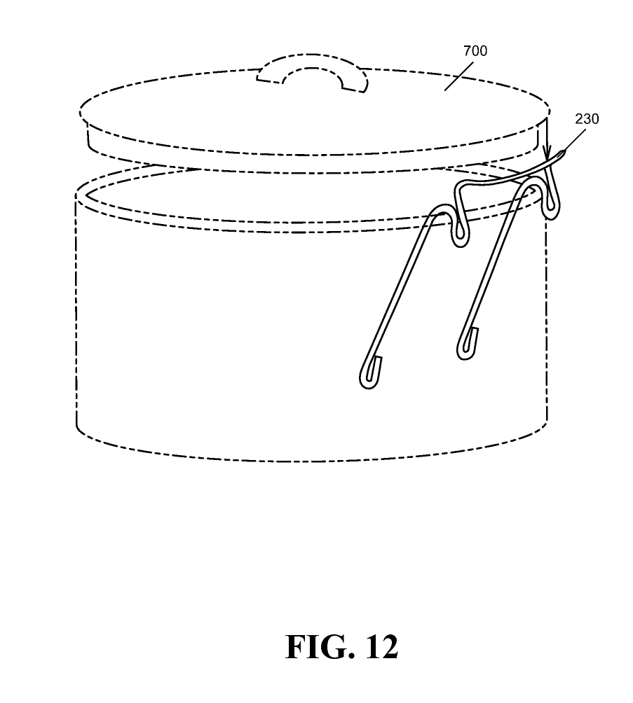

Referring to the drawings, FIGS. 1-12, where like reference numerals designate corresponding parts throughout the several figures, reference is made first to FIG. 1 that illustrates a typical steamer insert apparatus 010 of the technology disclosed herein.

In an exemplary embodiment a steamer insert apparatus 010 comprises a steaming platform 100 and a plurality of support legs 200.

The steaming platform 100 is generally rounded and configured to self-adjust and to suspend from a rim 310 of the cooking pot 300. The steaming platform 100 is configured and dimensioned to be located within the cooking pot 300 in a suspended manner to provide a surface area 110 on which to place the first food item 400 for steaming. The steaming platform 100 is configured with an opening 120 through which to access the second food item 500 that is cooking in boiling water located below the steaming platform 100. The steaming platform 100 has a plurality of steam access areas 130. In an exemplary embodiment these steam access areas 130 are rectangular in shape and form a grid pattern. The steam access areas 130 can be formed to have a variety of shapes and sizes, both uniform and non-uniform, e.g. very small circular holes.

The plurality of support legs 200 are connected to the steaming platform 100 and freely hang from the steaming platform 100. A hook 220 is formed at an upper end 210 of each support leg 200. The support legs 200 are configured to be placed over the rim 310 of the cooking pot 300.

The opening 120 with which to access the second food item 500 cooking below the steaming platform 100 is shaped generally in the form of a cross, thereby allowing the second food item 500 in the cooking pot 300 to pass through a first portion 121 of the cross-shaped area while being grasped by a cooking utensil 600, the cooking utensil 600 passing through a first portion 122 of the cross-shaped area.

The plurality of support legs 200 hingedly connect to the steaming platform 100 and are freely rotatable in order to be inserted into cooking pots that vary in size and diameter.

In one embodiment the support legs 200 consist of two support legs where the legs are located on opposite sides of the rim 310 of the cooking pot 300, each leg forming a handle with which to lift the steamer insert apparatus 010 to place on the rim 310 of the cooking pot 300.

The support legs 200 can be comprised of greater than two pairs of support legs 200 and be configured to balance a lid 700 to the cooking pot 300. The weight of the plurality of support legs 200 causes the support legs 200 to remain in an outstretched position such that when the steaming platform 100 is lowered into the cooking pot, the support legs 200 automatically adjust and the hooked upper ends 210 of the support legs 200 grasp the rim of the cooking pot.

In one embodiment the steaming platform 100 is comprised of a grill grate.

A method for steaming a first food item in a suspended manner in a cooking pot that is used to cook a second food item, the method comprises:
utilizing a steamer insert apparatus comprising:
   a steaming platform 100, the steaming platform 100 being generally rounded and configured to self-adjust and to suspend from a rim of a cooking pot, the steaming platform 100 being located within the cooking pot in a suspended manner to provide a surface area on which to place a first food item for steaming, the steaming platform 100 configured with an opening 120 with which to access a second food item to cook in water located below the steaming platform 100; and
   a plurality of support legs 200 connected to the steaming platform 100 and freely hanging from the steaming platform 100, the plurality of support legs 200 forming a hook at an upper end 210 of each of the plurality of support legs 200, and the plurality of support legs 200 being configured to be placed over the rim of the cooking pot;
placing the steaming platform 100 within the cooking pot such that the plurality of support legs 200 over the rim of the cooking pot;
placing a second food item within the cooking pot by passing the second food item through the opening 120 of the steaming platform 100;
heating the water in the cooking pot to cook the second food item and to create steam to rise to the steaming platform 100;
placing a first food item upon the steaming platform 100 so that is will be steamed; and
removing the second food item, once cooked, through the opening 120 in the steaming platform 100,
where the opening 120 with which to access the second food item cooking below the steaming platform 100 is shaped generally in the form of a cross, thereby allowing the second food item in the cooking pot to pass through a first portion 121 of the cross-shaped area while being grasped by a cooking utensil 600, the cooking utensil 600 passing through a first portion 122 of the cross-shaped area.

Another method for steaming a first food item in a suspended manner in a cooking pot that is used to cook a second food item, the method comprises:
utilizing a steamer insert apparatus comprising:
   a steaming platform 100, the steaming platform 100 being generally rounded and configured to self-adjust and to suspend from a rim of a cooking pot, the steaming platform 100 being located within the cooking pot in a suspended manner to provide a surface area on which to place a first food item for steaming, the steaming platform 100 configured with an opening 120 with which to access a second food item to cook in water located below the steaming platform 100; and
   a plurality of support legs 200 connected to the steaming platform 100 and freely hanging from the steaming platform 100, the plurality of support legs 200 forming a hook at an upper end 210 of each of the plurality of support legs 200, and the plurality of support legs 200 being configured to be placed over the rim of the cooking pot;
placing the steaming platform 100 within the cooking pot such that the plurality of support legs 200 over the rim of the cooking pot;
placing a second food item within the cooking pot by passing the second food item through the opening 120 of the steaming platform 100;
heating the water in the cooking pot to cook the second food item and to create steam to rise to the steaming platform 100;
placing a first food item upon the steaming platform 100 so that is will be steamed; and
removing the second food item, once cooked, through the opening 120 in the steaming platform 100,
where the plurality of support legs 200 hingedly connected to the steaming platform 100 are freely rotatable in order to be inserted into a plurality of cooking pots varied in size and diameter,

Yet another method for steaming a first food item in a suspended manner in a cooking pot that is used to cook a second food item, the method comprises:
utilizing a steamer insert apparatus comprising:
   a steaming platform 100, the steaming platform 100 being generally rounded and configured to self-adjust and to suspend from a rim of a cooking pot, the steaming platform 100 being located within the cooking pot in a suspended manner to provide a surface area on which to place a first food item for steaming, the steaming platform 100 configured with an opening 120 with which to access a second food item to cook in water located below the steaming platform 100; and
   a plurality of support legs 200 connected to the steaming platform 100 and freely hanging from the steaming platform 100, the plurality of support legs 200 forming a hook at an upper end 210 of each of the plurality of support legs 200, and the plurality of support legs 200 being configured to be placed over the rim of the cooking pot;
placing the steaming platform 100 within the cooking pot such that the plurality of support legs 200 over the rim of the cooking pot;
placing a second food item within the cooking pot by passing the second food item through the opening 120 of the steaming platform 100;
heating the water in the cooking pot to cook the second food item and to create steam to rise to the steaming platform 100;
placing a first food item upon the steaming platform 100 so that is will be steamed; and
removing the second food item, once cooked, through the opening 120 in the steaming platform 100,
where the plurality of support legs 200 hingedly connected to the steaming platform 100 is comprised of two or more pairs of support legs 200, being located on opposite sides of the rim of the cooking pot, each pair forming a handle with which to lift the steamer insert apparatus to place on the rim of the cooking pot.

Still another method for steaming a first food item in a suspended manner in a cooking pot that is used to cook a second food item comprises:
utilizing a steamer insert apparatus comprising:
   a steaming platform 100, the steaming platform 100 being generally rounded and configured to self-adjust and to suspend from a rim of a cooking pot, the steaming platform 100 being located within the cooking pot in a suspended manner to provide a surface area on which to place a first food item for steaming, the steaming platform 100 configured with an opening 120 with which to access a second food item to cook in water located below the steaming platform 100; and
   a plurality of support legs 200 connected to the steaming platform 100 and freely hanging from the steaming platform 100, the plurality of support legs 200 forming a hook at an upper end 210 of each of the plurality of support legs 200, and the plurality of support legs 200 being configured to be placed over the rim of the cooking pot;
placing the steaming platform 100 within the cooking pot such that the plurality of support legs 200 over the rim of the cooking pot;
placing a second food item within the cooking pot by passing the second food item through the opening 120 of the steaming platform 100;
heating the water in the cooking pot to cook the second food item and to create steam to rise to the steaming platform 100;
placing a first food item upon the steaming platform 100 so that is will be steamed; and
removing the second food item, once cooked, through the opening 120 in the steaming platform 100,
where the plurality of support legs 200 hingedly connected to the steaming platform 100 is comprised of greater than two pairs of support legs 200 and wherein the plurality of support legs 200 hingedly connected to the steaming platform 100, once placed on the cooking pot, are configured to balance a lid 700 to the cooking pot.

Another method for steaming a first food item in a suspended manner in a cooking pot that is used to cook a second food item comprises:
utilizing a steamer insert apparatus comprising:
   a steaming platform 100, the steaming platform 100 being generally rounded and configured to self-adjust and to suspend from a rim of a cooking pot, the steaming platform 100 being located within the cooking pot in a suspended manner to provide a surface area on which to place a first food item for steaming, the steaming platform 100 configured with an opening 120 with which to access a second food item to cook in water located below the steaming platform 100; and
   a plurality of support legs 200 connected to the steaming platform 100 and freely hanging from the steaming platform 100, the plurality of support legs 200 forming a hook at an upper end 210 of each of the plurality of support legs 200, and the plurality of support legs 200 being configured to be placed over the rim of the cooking pot;
placing the steaming platform 100 within the cooking pot such that the plurality of support legs 200 over the rim of the cooking pot;
placing a second food item within the cooking pot by passing the second food item through the opening 120 of the steaming platform 100;
heating the water in the cooking pot to cook the second food item and to create steam to rise to the steaming platform 100;
placing a first food item upon the steaming platform 100 so that is will be steamed; and
removing the second food item, once cooked, through the opening 120 in the steaming platform 100,
where the weight of the plurality of support legs 200 hingedly connected to a circumference of the steaming platform 100 causes the support legs 200 to remain in an outstretched position such that when the steaming platform 100 is lowered into the cooking pot, the support legs 200 automatically adjust and the hooked upper ends 210 of the support legs 200 grasp the rim of the cooking pot.

In one embodiment the technology disclosed herein is a hot dog bun steamer for steaming a hot dog bun in a suspended manner in a cooking pot that is used to cook a hot dog comprising:
a steaming platform 100, the steaming platform 100 being generally rounded and configured to self-adjust and to suspend from a rim of a cooking pot, the steaming platform 100 being located within the cooking pot in a suspended manner to provide a surface area on which to place a hot dog bun for steaming, the steaming platform 100 configured with a pass-through opening 120 with which to place, access, and remove a hot dog cooking in water located below the steaming platform 100; and
a plurality of support legs 200 connected to the steaming platform 100 and freely hanging from the steaming platform 100, the plurality of support legs 200 forming a hook 220 at an upper end 210 of each of the plurality of support legs 200, and the plurality of support legs 200 being configured to be placed over the rim of the cooking pot, where the opening 120 with which to access the hot dog cooking below the steaming platform 100 is shaped generally in the form of a cross, thereby allowing the hot dog in the cooking pot to pass through a first portion 121 of the cross-shaped area while being grasped by a set of tongs, the set of tongs passing through a first portion 122 of the cross-shaped area.

In another embodiment the technology disclosed herein is a hot dog bun steamer for steaming a hot dog bun in a suspended manner in a cooking pot that is used to cook a hot dog comprising:
a steaming platform 100, the steaming platform 100 being generally rounded and configured to self-adjust and to suspend from a rim of a cooking pot, the steaming platform 100 being located within the cooking pot in a suspended manner to provide a surface area on which to place a hot dog bun for steaming, the steaming platform 100 configured with a pass-through opening 120 with which to place, access, and remove a hot dog cooking in water located below the steaming platform 100; and
   a plurality of support legs 200 connected to the steaming platform 100 and freely hanging from the steaming platform 100, the plurality of support legs 200 forming a hook 220 at an upper end 210 of each of the plurality of support legs 200, and the plurality of support legs 200 being configured to be placed over the rim of the cooking pot, where the plurality of support legs 200 hingedly connected to the steaming platform 100 are freely rotatable in order to be inserted into a plurality of cooking pots varied in size and diameter.

In still another embodiment the technology disclosed herein is a hot dog bun steamer for steaming a hot dog bun in a suspended manner in a cooking pot that is used to cook a hot dog comprising:
a steaming platform 100, the steaming platform 100 being generally rounded and configured to self-adjust and to suspend from a rim of a cooking pot, the steaming platform 100 being located within the cooking pot in a suspended manner to provide a surface area on which to place a hot dog bun for steaming, the steaming platform 100 configured with a pass-through opening 120 with which to place, access, and remove a hot dog cooking in water located below the steaming platform 100; and
   a plurality of support legs 200 connected to the steaming platform 100 and freely hanging from the steaming platform 100, the plurality of support legs 200 forming a hook 220 at an upper end 210 of each of the plurality of support legs 200, and the plurality of support legs 200 being configured to be placed over the rim of the cooking pot, where the plurality of support legs 200 hingedly connected to the steaming platform 100 is comprised of two or more pairs of support legs 200, being located on opposite sides of the rim of the cooking pot, each pair forming a handle with which to lift the steamer insert apparatus to place on the rim of the cooking pot.

In one more embodiment the technology disclosed herein is a hot dog bun steamer for steaming a hot dog bun in a suspended manner in a cooking pot that is used to cook a hot dog comprising:
a steaming platform 100, the steaming platform 100 being generally rounded and configured to self-adjust and to suspend from a rim of a cooking pot, the steaming platform 100 being located within the cooking pot in a suspended manner to provide a surface area on which to place a hot dog bun for steaming, the steaming platform 100 configured with a pass-through opening 120 with which to place, access, and remove a hot dog cooking in water located below the steaming platform 100; and
   a plurality of support legs 200 connected to the steaming platform 100 and freely hanging from the steaming platform 100, the plurality of support legs 200 forming a hook 220 at an upper end 210 of each of the plurality of support legs 200, and the plurality of support legs 200 being configured to be placed over the rim of the cooking pot, where the plurality of support legs 200 hingedly connected to the steaming platform 100, once placed on the cooking pot, are configured to balance a lid 700 to the cooking pot.

In one embodiment the technology disclosed herein is a hot dog bun steamer for steaming a hot dog bun in a suspended manner in a cooking pot that is used to cook a hot dog comprising:
a steaming platform 100, the steaming platform 100 being generally rounded and configured to self-adjust and to suspend from a rim of a cooking pot, the steaming platform 100 being located within the cooking pot in a suspended manner to provide a surface area on which to place a hot dog bun for steaming, the steaming platform 100 configured with a pass-through opening 120 with which to place, access, and remove a hot dog cooking in water located below the steaming platform 100; and
   a plurality of support legs 200 connected to the steaming platform 100 and freely hanging from the steaming platform 100, the plurality of support legs 200 forming a hook 220 at an upper end 210 of each of the plurality of support legs 200, and the plurality of support legs 200 being configured to be placed over the rim of the cooking pot, where the weight of the plurality of support legs 200 hingedly connected to a circumference of the steaming platform 100 causes the support legs 200 to remain in an outstretched position such that when the steaming platform 100 is lowered into the cooking pot, the support legs 200 automatically adjust and the hooked upper ends 210 of the support legs 200 grasp the rim of the cooking pot.

In one embodiment the technology disclosed herein is a hot dog bun steamer for steaming a hot dog bun in a suspended manner in a cooking pot that is used to cook a hot dog comprising:
a steaming platform 100, the steaming platform 100 being generally rounded and configured to self-adjust and to suspend from a rim of a cooking pot, the steaming platform 100 being located within the cooking pot in a suspended manner to provide a surface area on which to place a hot dog bun for steaming, the steaming platform 100 configured with a pass-through opening 120 with which to place, access, and remove a hot dog cooking in water located below the steaming platform 100; and
   a plurality of support legs 200 connected to the steaming platform 100 and freely hanging from the steaming platform 100, the plurality of support legs 200 forming a hook 220 at an upper end 210 of each of the plurality of support legs 200, and the plurality of support legs 200 being configured to be placed over the rim of the cooking pot, where the opening 120 is comprised of a cross-shaped opening 120 with a first cross bar having a length of approximately five inches, where a hot dog passes through the opening 120, and a second cross bar having a length of approximately three inches to accommodate a pair of tongs grasping the width of a hot dog, the first and second cross bars of the opening 120 allowing the pair of tongs and a hot dog to pass through the opening 120 while the hot dog is being grasped.

The foregoing description and drawings comprise illustrative embodiments of the technology disclosed herein. Having thus described exemplary embodiments of the technology disclosed herein, it should be noted by those skilled in the art that the within disclosures are exemplary only, and that various other alternatives, adaptations and modifications may be made within the scope of the technology disclosed herein. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing description and the associated drawings. Although specific terms may be employed herein, they are used in a generic and descriptive sense only and not for purposes of limitation. Accordingly, the technology disclosed herein is not limited to the specific embodiments illustrated herein, but is limited only by the following claims.

What is claimed is:

1. A steamer insert apparatus for steaming a first food item in a suspended manner in a cooking pot that is used to cook a second food item, the apparatus comprising:
a steaming platform, the steaming platform being generally rounded and configured to self-adjust and to suspend from a rim of a cooking pot, the steaming platform being located within the cooking pot in a suspended manner to provide a surface area on which to place a first food item for steaming, the steaming platform configured with an opening through which to access a second food item to cook in water located below the steaming platform; and
a plurality of support legs connected to the steaming platform and freely hanging from the steaming platform, the plurality of support legs forming a hook at an upper end of each of the plurality of support legs, and the plurality of support legs being configured to be placed over the rim of the cooking pot.

2. The steamer insert apparatus for steaming a first food item in a suspended manner in a cooking pot that is used to cook a second food item of claim 1, wherein the opening with which to access the second food item cooking below the steaming platform is shaped generally in the form of a cross, thereby allowing the second food item in the cooking pot to pass through a first portion of the cross-shaped area while being grasped by a cooking utensil, the cooking utensil passing through a second portion of the cross-shaped area.

3. The steamer insert apparatus for steaming a first food item in a suspended manner in a cooking pot that is used to cook a second food item of claim 1, wherein the plurality of support legs hingedly connected to the steaming platform are freely rotatable in order to be inserted into a plurality of cooking pots varied in size and diameter.

4. The steamer insert apparatus for steaming a first food item in a suspended manner in a cooking pot that is used to cook a second food item of claim 1, wherein the plurality of support legs hingedly connected to the steaming platform is comprised of two or more pairs of support legs, being located on opposite sides of the rim of the cooking pot, each pair forming a handle with which to lift the steamer insert apparatus to place on the rim of the cooking pot.

5. The steamer insert apparatus for steaming a first food item in a suspended manner in a cooking pot that is used to cook a second food item of claim 1, wherein the plurality of support legs hingedly connected to the steaming platform is comprised of greater than two pairs of support legs and wherein the plurality of support legs hingedly connected to the steaming platform, once placed on the cooking pot, are configured to balance a lid to the cooking pot.

6. The steamer insert apparatus for steaming a first food item in a suspended manner in a cooking pot that is used to cook a second food item of claim 1, wherein the weight of the plurality of support legs hingedly connected to a circumference of the steaming platform causes the support legs to remain in an outstretched position such that when the steaming platform is lowered into the cooking pot, the support legs automatically adjust and the hooked upper ends of the support legs grasp the rim of the cooking pot.

7. A method for steaming a first food item in a suspended manner in a cooking pot that is used to cook a second food item, the method comprising:
utilizing a steamer insert apparatus comprising:
a steaming platform, the steaming platform being generally rounded and configured to self-adjust and to suspend from a rim of a cooking pot, the steaming platform being located within the cooking pot in a suspended manner to provide a surface area on which to place a first food item for steaming, the steaming platform configured with an opening with which to access a second food item to cook in water located below the steaming platform; and
a plurality of support legs connected to the steaming platform and freely hanging from the steaming platform, the plurality of support legs forming a hook at an upper end of each of the plurality of support legs, and the plurality of support legs being configured to be placed over the rim of the cooking pot;
placing the steaming platform within the cooking pot such that the plurality of support legs over the rim of the cooking pot;
placing a second food item within the cooking pot by passing the second food item through the opening of the steaming platform;
heating the water in the cooking pot to cook the second food item and to create steam to rise to the steaming platform;
placing a first food item upon the steaming platform so that is will be steamed; and
removing the second food item, once cooked, through the opening in the steaming platform.

8. The method for steaming a first food item in a suspended manner in a cooking pot that is used to cook a second food item of claim 7, wherein the opening with which to access the second food item cooking below the steaming platform is shaped generally in the form of a cross, thereby allowing the second food item in the cooking pot to pass through a first portion of the cross-shaped area while being grasped by a cooking utensil, the cooking utensil passing through a second portion of the cross-shaped area.

9. The method for steaming a first food item in a suspended manner in a cooking pot that is used to cook a second food item of claim 7, wherein the plurality of support legs hingedly connected to the steaming platform are freely rotatable in order to be inserted into a plurality of cooking pots varied in size and diameter.

10. The method for steaming a first food item in a suspended manner in a cooking pot that is used to cook a second food item of claim 7, wherein the plurality of support legs hingedly connected to the steaming platform is comprised of two or more pairs of support legs, being located on opposite sides of the rim of the cooking pot, each pair forming a handle with which to lift the steamer insert apparatus to place on the rim of the cooking pot.

11. The method for steaming a first food item in a suspended manner in a cooking pot that is used to cook a second food item of claim 7, wherein the plurality of support legs hingedly connected to the steaming platform is comprised of greater than two pairs of support legs and wherein the plurality of support legs hingedly connected to the steaming platform, once placed on the cooking pot, are configured to balance a lid to the cooking pot.

12. The method for steaming a first food item in a suspended manner in a cooking pot that is used to cook a second food item of claim 7, wherein the weight of the plurality of support legs hingedly connected to a circumference of the steaming platform causes the support legs to remain in an outstretched position such that when the steaming platform is lowered into the cooking pot, the support legs automatically adjust and the hooked upper ends of the support legs grasp the rim of the cooking pot.

13. A hot dog bun steamer for steaming a hot dog bun in a suspended manner in a cooking pot that is used to cook a hot dog, the hot dog bun steamer comprising:
a steaming platform, the steaming platform being generally rounded and configured to self-adjust and to suspend from a rim of a cooking pot, the steaming platform being located within the cooking pot in a suspended manner to provide a surface area on which to place a hot dog bun for steaming, the steaming platform configured with a pass-through opening with which to place, access, and remove a hot dog cooking in water located below the steaming platform; and
a plurality of support legs connected to the steaming platform and freely hanging from the steaming platform, the plurality of support legs forming a hook at an upper end of each of the plurality of support legs, and the plurality of support legs being configured to be placed over the rim of the cooking pot.

14. The hot dog bun steamer for steaming a hot dog bun in a suspended manner in a cooking pot that is used to cook a hot dog of claim 13, wherein the opening with which to access the hot dog cooking below the steaming platform is shaped generally in the form of a cross, thereby allowing the hot dog in the cooking pot to pass through a first portion of the cross-shaped area while being grasped by a set of tongs, the set of tongs passing through a second portion of the cross-shaped area.

15. The hot dog bun steamer for steaming a hot dog bun in a suspended manner in a cooking pot that is used to cook a hot dog of claim 13, wherein the plurality of support legs hingedly connected to the steaming platform are freely rotatable in order to be inserted into a plurality of cooking pots varied in size and diameter.

16. The hot dog bun steamer for steaming a hot dog bun in a suspended manner in a cooking pot that is used to cook a hot dog of claim 13, wherein the plurality of support legs hingedly connected to the steaming platform is comprised of two or more pairs of support legs, being located on opposite sides of the rim of the cooking pot, each pair forming a handle with which to lift the steamer insert apparatus to place on the rim of the cooking pot.

17. The hot dog bun steamer for steaming a hot dog bun in a suspended manner in a cooking pot that is used to cook a hot dog of claim 13, wherein the plurality of support legs hingedly connected to the steaming platform is comprised of greater than two pairs of support legs and wherein the plurality of support legs hingedly connected to the steaming platform, once placed on the cooking pot, are configured to balance a lid to the cooking pot.

18. The hot dog bun steamer for steaming a hot dog bun in a suspended manner in a cooking pot that is used to cook a hot dog of claim 13, wherein the weight of the plurality of support legs hingedly connected to a circumference of the steaming platform causes the support legs to remain in an outstretched position such that when the steaming platform is lowered into the cooking pot, the support legs automatically adjust and the hooked upper ends of the support legs grasp the rim of the cooking pot.

19. The hot dog bun steamer for steaming a hot dog bun in a suspended manner in a cooking pot that is used to cook a hot dog of claim 13, wherein the steaming platform is approximately six inches in diameter and wherein the opening is comprised of a cross-shaped opening with a first cross bar having a length of approximately five inches, where a hot dog passes through the opening, and a second cross bar having a length of approximately three inches to accommodate a pair of tongs grasping the width of a hot dog, the first and second cross bars of the opening allowing the pair of tongs and a hot dog to pass through the opening while the hot dog is being grasped.

20. The steamer insert apparatus for steaming a first food item in a suspended manner in a cooking pot that is used to cook a second food item of claim 1, wherein the steaming platform is comprised of a grill grate.
